(19) United States
(12) Patent Application Publication
(10) Pub. No.: US 2010/0290128 A1
(43) Pub. Date: Nov. 18, 2010

(54) OPTICAL MODULE

(75) Inventor: Atsushi SUGITATSU, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: MITSUBISHI ELECTRIC CORPORATION, Chiyoda-ku (JP)

(21) Appl. No.: 12/582,039

(22) Filed: Oct. 20, 2009

(30) Foreign Application Priority Data
May 13, 2009 (JP) 2009-116852

(51) Int. Cl. G02B 27/14

(52) U.S. Cl. 359/634

(57) ABSTRACT

A plurality of prisms each has side surfaces that forms an angle of 90 degrees functions as a wavelength filter, and the prisms are arranged so that the angles of 90 degrees of adjacent prisms are pointing in opposite directions so as to form one wavelength separation filter by bonding the prisms together. With this configuration, a path of light output from the wavelength separation filter is displaced as an orientation of the wavelength separation filter changes; however, the path of the light after displacement is not inclined to but parallel to the path of the light before displacement.

### BACKGROUND OF THE INVENTION

1. Field of the Invention

The present invention relates to an optical module that is used in light-receiving or light-transmitting devices that are used in optical communications.

2. Description of the Related Art

There is a growing demand for the transmission of large volumes of contents, such as high-quality moving-image data, over communication networks, especially the Internet; therefore, in the field of communication media, optical fibers, which provide high-speed communications, are widely used. Furthermore, wavelength-division multiplexing (WDM) technology has been put to a practical use. WDM is a technology that allows optical signals having different wavelengths to be carried on a single optical fiber so that signals of more than one optical channel can be transmitted using a single fiber.

When receiving wavelength-division multiplexed signals, a receiver splits the signals by their wavelengths using a decoupler. In the article “Bidirectional optical multiplexer/demultiplexer with built-in light-emitting/light-receiving element” (Tamura et al., Denshitushingakkai Sogozenkokutaikai Ronbunshu (1984), 2656, Vol. 10, p. 356, Mar. 5, 1984) a technology for splitting multiplexed optical signals that have different wavelengths into their individual wavelengths using a wavelength separation filter is disclosed.

More particularly, when a light enters a receiver through an input port, a collimating lens collimates the light and outputs the collimated light to a wavelength separation filter. The wavelength separation filter separates the collimated light into a light of different wavelengths using a plurality of half mirrors that operate as filters. The light separated by wavelengths passes through a half mirror and further passes through an imaging lens. The light then forms an image on a light-receiving element.

In the above-described conventional technology, as the angle of the wavelength separation filter changes, the direction in which the collimated light travels also changes, which causes inadequate focusing on the light-receiving lens by the imaging lens. Therefore, there is a need to improve the stability of sensitivity of the optical module. Furthermore, because the position at which the beam spot falls on the light-receiving element needs to be adjusted accurately with respect to the diameter of the light-receiving element, it is necessary to attach the light-receiving element with high accuracy. For this reason, the conventional optical module is expensive and difficult to fabricate.

### SUMMARY OF THE INVENTION

It is an object of the present invention to at least partially solve the problems in the conventional technology.

The optical module according to one aspect of the present invention is constructed in such a manner that it includes at least one wavelength separation unit that has side surfaces making an angle of 90 degrees, each of the side surfaces functioning as a wavelength filter that performs a wavelength selection on incident light; and at least one light-receiving unit that receives the light from the wavelength separation unit, after the light enters and then exits the wavelength separation unit by way of the wavelength filter.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of a light-receiving device that includes an optical module according to a first embodiment of the present invention;

FIG. 2 is a schematic diagram for explaining that even if a path of an output light is displaced as the orientation of a prism changes, the path of the output light after displacement is not inclined to but parallel to the output light before displacement;

FIG. 3 is a schematic diagram of a conventional light-receiving device;

FIG. 4 is a schematic diagram of a light-receiving device that includes an optical module according to a second embodiment of the present invention;

FIG. 5 is a light-receiving device that includes an optical module according to a third embodiment of the present invention;

FIG. 6 is a light-receiving device that includes an optical module according to a fourth embodiment of the present invention; and

FIG. 7 is a schematic diagram of a light-transmitting device that includes an optical module according to a fifth embodiment of the present invention.

### DETAILED DESCRIPTION OF THE PREFERRED EMBODIMENTS

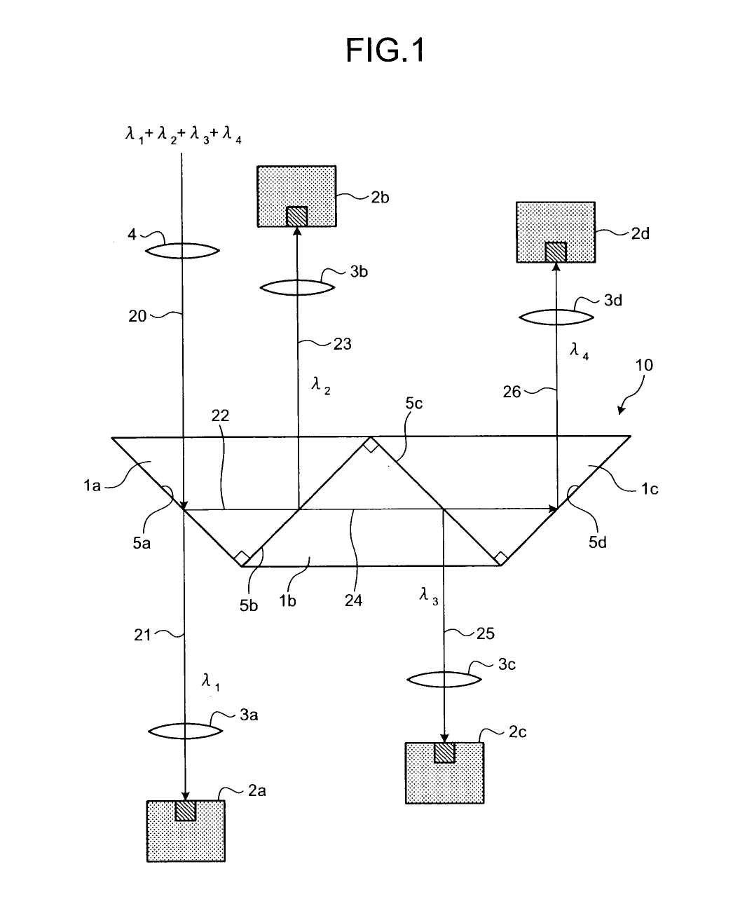

Exemplary embodiments of the present invention are described in detail below with reference to the accompanying drawings. FIG. 1 is a schematic diagram of a light-receiving device that includes an optical module according to a first embodiment of the present invention. The light-receiving device shown in FIG. 1 is a 4-channel light-receiving module capable of receiving four channels of multiplexed optical signals having four different wavelengths.

The light-receiving device includes a wavelength separation filter 10, a collimating lens 4, a plurality of light-receiving elements 2a, 2b, 2c and 2d, and a plurality of imaging lenses 3a, 3b, 3c and 3d. When receiving optical signals, the collimating lens 4 converts the optical signals to collimated light and outputs the collimated light to the wavelength separation filter 10. The wavelength separation filter 10 separates the optical signals by their wavelengths. Each of the light-receiving elements 2a, 2b, 2c and 2d receives a corresponding one of the optical signals that are separated by the wavelength separation filter 10. The imaging lenses 3a, 3b, 3c and 3d guide the separated optical signals that are output from the wavelength separation filter 10 to the light-receiving elements 2a, 2b, 2c and 2d, respectively.

The wavelength separation filter 10 is formed by bonding a plurality of prisms 1a, 1b, and 1c each having an apex of 90 degrees. The prisms 1a, 1b, and 1c are arranged so that the apexes of adjacent prisms are pointing in opposite directions. More particularly, each of the prisms 1a, 1b, and 1c has a pair of surfaces that make the apex of 90 degrees. One of the surfaces of the prism 1a is bonded to one of the surfaces of the prism 1b with the apexes of the prisms 1a and 1b pointing in opposite directions on the bonded plane. The other surface of the prism 1b is bonded to one of the surfaces of the prism 1c with the apexes of the prisms 1b and 1c pointing in opposite directions on the bonded plane. Each of the surfaces that make the apex of 90 degrees in each of the prisms 1a, 1b and 1c is a half mirror that functions as a wavelength filter or a total reflection surface. A wavelength filter uses, for example, a multilayer film to allow only a desired light having a predetermined wavelength to pass through or reflect only a desired light. Although the cross section of the prisms 1a, 1b and 1c is an isosceles triangle as shown in FIG. 1, the shape of prisms is not limited thereto. The cross section of the prisms 1a, 1b and 1c can be, for example, a scalene.

In the example shown in FIG. 1, a surface 5a of the prism 1a is a first wavelength filter that allows an optical signal having a wavelength λ₁ to pass through and reflects optical signals having wavelengths other than λ₁. A surface 5b where the prism 1a and the prism 1b are boded is a second wavelength filter that reflects an optical signal having a wavelength λ₂ and allows optical signals having wavelengths other than λ₂ to pass through. A surface 5c where the prism 1b and the prism 1c are bonded is a third wavelength filter that reflects an optical signal having a wavelength λ₃ and allows an optical signal having a wavelength λ₄ to pass through. There are no more surfaces inside the wavelength separation filter 10 further than a surface 5d. The surface 5d is formed, for example, as a total reflection surface that totally reflects incident light.

When an incident light 20 composed of multiplexed optical signals having the wavelengths λ₁, λ₂, λ₃ and λ₄ enters the prism 1a after having passed through the collimating lens 4, the incident light 20 is directed to the first wavelength filter, i.e., the surface 5a. A light 21 having the wavelength λ₁ is separated from the incident light 20 by the first wavelength filter, and passes through the imaging lens 3a to forms an image on the light-receiving element 2a. The light composed of the optical signals having the wavelengths λ₂, λ₃ and λ₄ (hereinafter, “light 22”) is reflected by the surface 5a, and irradiated to the second wavelength filter, i.e., the surface 5b.

A light 23 having the wavelength λ₂ is separated from the light 22 due to the reflection of the second wavelength filter, and passes through the imaging lens 3b to form an image on the light-receiving element 2b. The light composed of the optical signals having the wavelengths λ₃ and λ₁ (hereinafter, “light 24”) passes through the surface 5b and travels inside the prism 1b to the third wavelength filter, i.e., the surface 5c.

A light 25 having the wavelength λ₃ is separated from the light 24 due to the reflection of the third wavelength filter, and passes through the imaging lens 3c to form an image on the light-receiving element 2c. The light having the wavelength λ₄ (hereinafter, “light 26”) passes through the surface 5c and travels inside the prism 1c to the surface 5d. The light 26 is totally reflected by the surface 5d. The reflected light 26 passes through the imaging lens 3d and forms thereafter an image on the light-receiving element 2d.

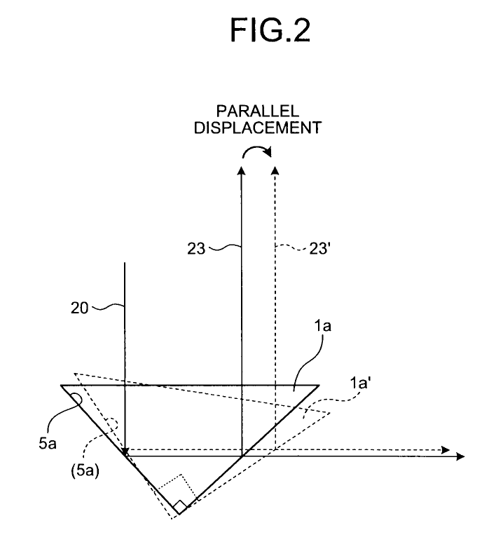

An effect of change in an orientation of the wavelength separation filter 10 against the incident light 20 is described below in the light-receiving device having the above-described configuration. Let us suppose now an example that the wavelength separation filter 10 is composed of the prism 1a only as shown in FIG. 2.

In the example shown in FIG. 2, it is assumed that the orientation of the prism 1a is displaced as indicated by a dotted line. The displaced prism 1a is called prism 1a′. Because the apical angle of the prism 1a in the first embodiment is 90 degrees, after reflected by the surface 5a and the surface 5b, the light 23 exits the prism la parallel to the incident light 20. Accordingly, the path of the light 23 is displaced as the orientation of the prism 1a changes; however, the path of a light 23′ after displacement shown in FIG. 2 is not inclined to but parallel to the path of the light 23.

The same effect is obtained by using the wavelength separation filter 10 shown in FIG. 1 that is formed by bonding the prisms so that the apexes of 90 degrees of adjacent prisms are pointing in opposite directions. In the example where the prism 1a and the prism 1b are bonded together so that the apexes of the prisms 1a and 1b are pointing in opposite directions, the surface 5c is parallel to the surface 5a. Therefore, the path of the light 25 that is reflected by the surface 5c is parallel to the path of the incident light 20. It means that, the path of the light 25 is displaced as the orientation of the wavelength separation filter 10 changes; however, the path of the light 25 after the displacement is not inclined to but parallel to the path before the displacement.

In the example where the prism 1c is bonded to the prism 1b so that the apexes of the prisms 1b and 1c are pointing opposite directions, the surface 5d of the prism 1c is parallel to the surface 5b of the prism la. Therefore, the path of the light 26 that is reflected by the surface 5d is parallel to the path of the incident light 20 in the same manner as the light 23 that is reflected by the surface 5b. It means that, the path of the light 26 is displaced as the orientation of the wavelength separation filter 10 changes; however, the path of the light 26 after the displacement is not inclined to but parallel to the path before the displacement.

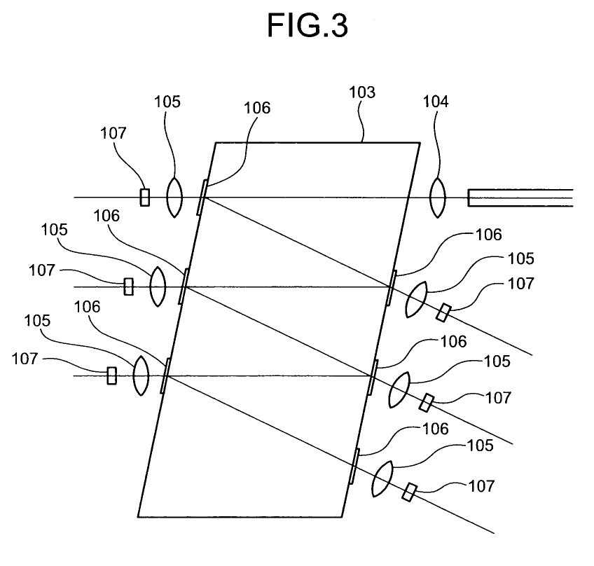

In a conventional light-receiving device shown in FIG. 3, a collimating lens 104 receives a light coming from an input port, converts the light into a collimated light, and outputs the collimated light to a wavelength separation filter 103. There are a plurality of filters 106 that function as a half mirror inside the wavelength separation filter 103. The wavelength separation filter 103 separates the collimated light into a plurality of different wavelengths of light using the filters 106 and outputs the separated wavelengths of light. Each of the separated wavelengths of light passes through an imaging lens 105 and then forms an image on a light-receiving element 107. In the conventional light-receiving device shown in FIG. 3, as the orientation of the wavelength separation filter 103 changes, the direction in which the collimated light travels also changes, which causes inadequate focusing on the light-receiving element 107 by the imaging lens 105.

The wavelength separation filter 10 in the first embodiment, in contrast, is formed by sequentially bonding the surfaces that make the apexes of the right-triangular prisms so that the apexes of adjacent prisms are pointing opposite directions on the bonded plane. With this configuration, the path of the light that is reflected by one of the surfaces that make the apex is made parallel to the path of the incident light. Therefore, even though the path of the light that exits each prism is displaced as the orientation of the wavelength separation filter 10 changes, the path of the light that exits each prism after displacement is not inclined to but parallel to the path before displacement.

It means that the light-receiving device can be produced without taking into consideration a degree of tolerance for non-parallel displacement caused by the wavelength separation filter 10. This makes it possible to maintain the sensitivity to the incident light 20 high enough for a long time. The light-receiving device thus operates properly for a long time.

In the first embodiment, the collimating lens 4 converts the incident light 20 into the collimated light and outputs the collimated light to the wavelength separation filter 10. With this configuration, even when a displacement occurs, the lights 21, 23, 25, and 26, which are the output lights from the wavelength separation filter 10, are displaced parallel by an extent corresponding to the displacement of the orientation of the wavelength separation filter 10. As a result, the displacement caused by an angle of the lights 21, 23, 25 and 26 that are incident on the light-receiving elements 2a, 2b, 2c and 2d is suppressed.

With this configuration, the efficiency of the light incident on the light-receiving elements 2a, 2b, 2c and 2d is improved, which will decrease, for example, an amount of the power consumption required for signal processing that is performed afterward.

Furthermore, the surface 5d, in the downstream of which no more wavelength separation surfaces are present inside the wavelength separation filter 10, is formed as a total reflection mirror that totally reflects the incident light. This is because the required wavelength separation is finished by the time the light reaches the surface 5c, and thus it is unnecessary to selectively reflect the light by the surface 5c.

Generally, the number of layers forming a total reflection surface that cannot selectively reflect incident light is smaller than the number of layers forming a wavelength selection surface. Accordingly, a low-cost and high-reliable wavelength separation filter can be produced by forming the most-downstream surface using a total reflection surface.

A second embodiment of the present invention is described below. In the first embodiment, when the incident light 20 enters the prism 1a from a base surface 40, the light 21 exits the prism 1a from the surface 5a, which is a slope surface corresponding to the incident position of the incident light 20, in a direction inclined an acute angle toward the apex. Because of the acute angle, when the light 21 enters an air layer passing through the prism 1a, the path of the light 21 is bent according to a difference between an index of refraction of a material (glass) making the prism 1a and the index of refraction of air. As a result, the path of the light 21 becomes inclined to the path of the incident light 20.

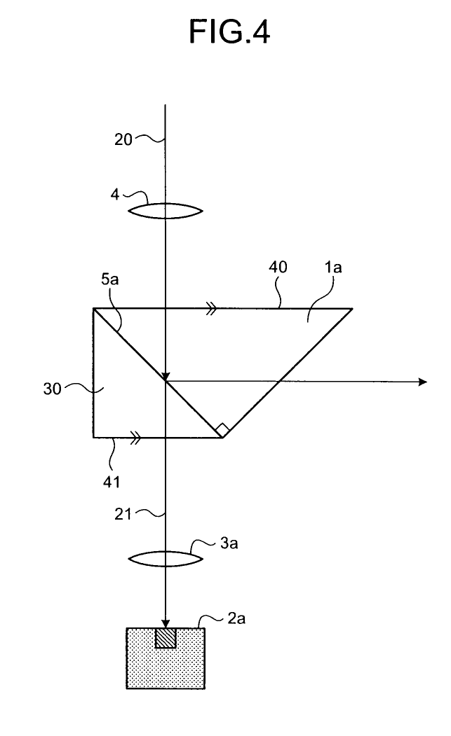

To solve the problem, in a light-receiving device according to the second embodiment shown in FIG. 4, a prism 30 is bonded to the surface 5a of the prism 1a from which the light 21 exits. More particularly, the prism 1a and the prism 30 are bonded together in such a manner that a surface 41 from which the light 21 exits becomes parallel to the base surface 40 from which the incident light 20 enters the prism 1a.

In other words, the prism 1a and the prism 30 are bonded together to form a single parallel plate. Accordingly, when the orientation of the wavelength separation filter 10 bonded with the prism 30 is displaced, even though the path of the output light 21 is displaced, the path of the output light 21 after the displacement is not inclined to but parallel to the path of the output light 21 before the displacement.

It means that the light-receiving device can be produced without taking into consideration a degree of tolerance for non-parallel displacement caused by the wavelength separation filter 10. This makes it possible to maintain the sensitivity to the incident light 20 high enough for a long time. The light-receiving device thus operates properly for a long time.

The lights 23, 25 and 26 exits substantially perpendicular to the base surfaces of the prisms 1a, 1b, and 1c, respectively; therefore, it is considered that refraction of the output light caused by the difference between the indices of refraction is small. As a result, the lights 23, 25 and 26 become substantially parallel to the light 21.

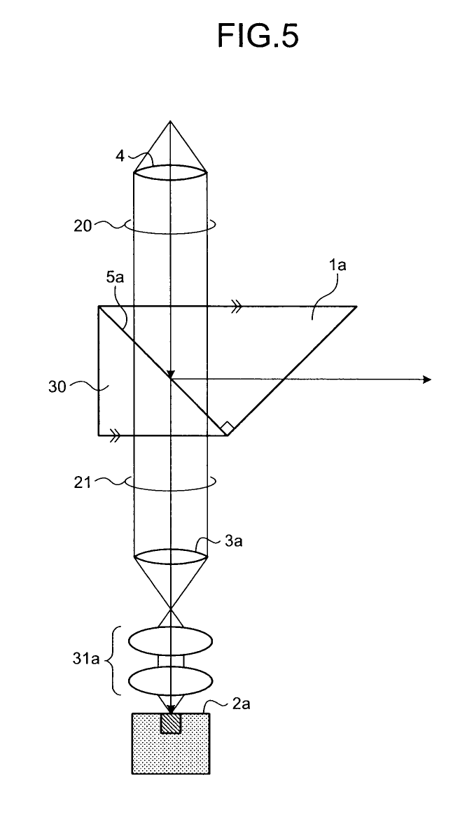

A third embodiment of the present invention is described below. FIG. 5 is a light-receiving device that includes an optical module according to the third embodiment. Only components related to the path of the light 21 are shown in FIG. 5 for simplicity. In the third embodiment, a telecentric optical system 31a is arranged between the imaging lens 3a and the light-receiving element 2a. The telecentric optical system 31a is image-space telecentric. The telecentric optical system 31a is arranged so that the light coming from the imaging point of the imaging lens 3a makes an image point at a reduced magnification. With this configuration, the light output from the imaging lens 3a always becomes substantially parallel to the optical axis; therefore, the displacement caused by an angle of the light incident on the light-receiving element 2a is suppressed in the light-receiving device.

With this configuration, the efficiency of the light incident on the light-receiving elements 2a is improved, which will decrease, for example, an amount of the power consumption required for signal processing that is performed afterward.

Although the telecentric optical system 31a is arranged only on the path of the light 21 in the example shown in FIG. 5, telecentric optical systems can be also arranged on the paths of the lights 23, 25, and 26.

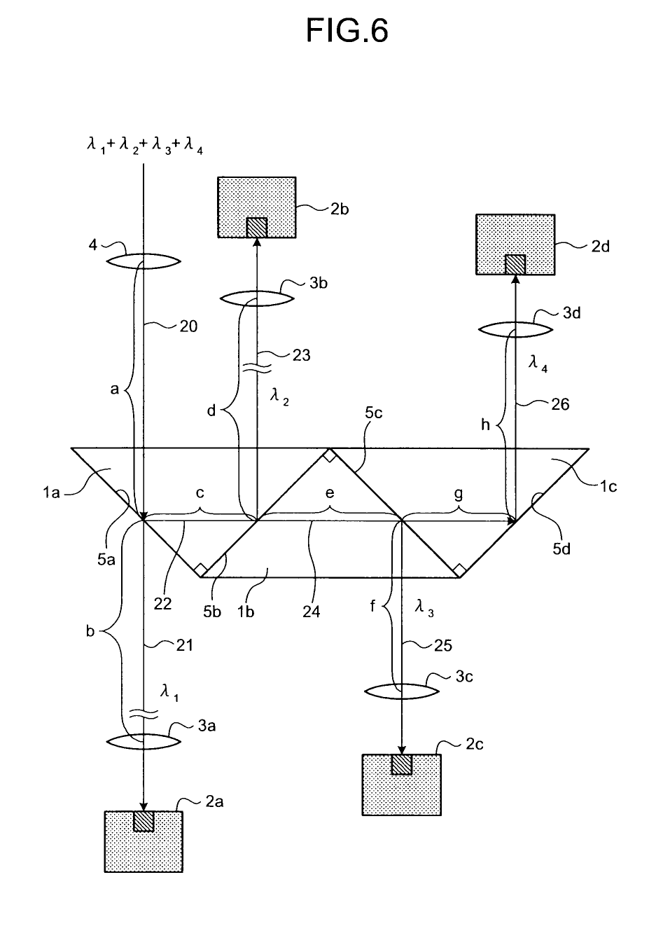

A fourth embodiment of the present invention is described below. FIG. 6 is a light-receiving device that includes an optical module according to the fourth embodiment. In the fourth embodiment, the length of a path along which the light having the wavelength λ₁ travels in the collimator optical system, the length of a path of the light having the wavelength λ₂, the length of a path of the light having the wavelength λ₃, and the length of a path of the light having the wavelength λ₁ are set equal. More specifically, the length of a path from the incident position, for example, the collimating lens 4 to each of the imaging lenses 3a, 3b, 3c and 3d corresponding to the light-receiving elements 2a, 2b, 2c and 2d is set equal.

In the example shown in FIG. 6, the length l₁ of the path from the collimating lens 4 to the imaging lens 3a is a+b; the length l, of the path from the collimating lens 4 to the imaging lens 3b is a+c+d; the length l₃ of the path from the collimating lens 4 to the imaging lens 3c is a+c+e+f; and the length l₄ of the path from the collimating lens 4 to the imaging lens 3d is a+c+e+g+h. The positions of the imaging lenses 3a, 3b, 3c, and 3d are determined in such a manner that Equation length l₁=length l₂=length l₃=length l₄ is satisfied. Because the parameter “a” is used in all the lengths l₁, l₂, l₃, and l₄, it is calculated to satisfy b=c+d=c+e+f=c+e+g+h.

Because the lights output from fibers or laser lights are based on Gaussian beams, they cannot be converted to identical parallel lights, strictly speaking. Therefore, the light cannot always be the parallel light as the light travels further, so that the range in which the light can be practically parallel is limited. In the fourth embodiment, because the lengths of the paths along which the lights having the wavelengths λ₁, λ₂, λ₃ and λ₄ travel in the collimator optical system are set equal, the optical system for each wavelength can be made the same. This makes it possible to share certain components and reduce fluctuation in the optical performances.

A fifth embodiment of the present invention is described below. A light transmitting device according to the fifth embodiment has the configuration almost the same as the light-receiving device according to the first embodiment that has been described with reference to FIG. 1 except that the light-receiving elements 2a, 2b, 2c, and 2d are replaced with light-emitting elements. Each of the light-emitting elements emits a light to the wavelength separation filter 10 reversely along the path of the above-described incident light 20. The lights are combined by the wavelength separation filter 10, and the combined light is output from the wavelength separation filter 10.

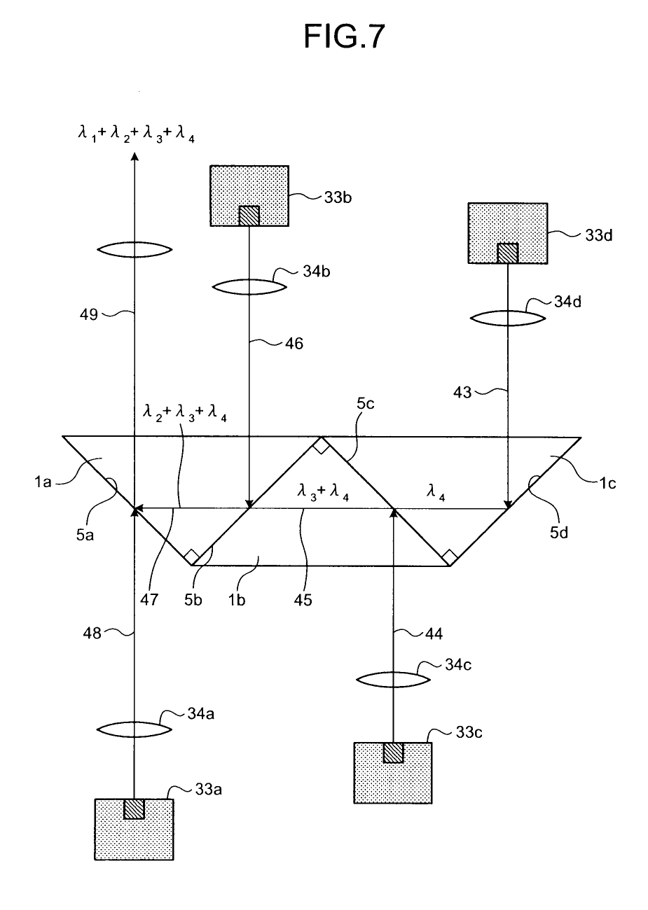

FIG. 7 is a schematic diagram of a light-transmitting device that includes an optical module according to the fifth embodiment. Each of a plurality of light-emitting elements 33a, 33b, 33c and 33d emits light having the wavelengths λ₁, λ₂, λ₃ and λ₄, respectively. The lights that are emitted by the light-emitting elements 33a, 33b, 33c and 33d enter the wavelength separation filter 10, passing through lenses 34a, 34b, 34c and 34d, respectively. The lights that are emitted by the light-emitting elements 33a, 33b, 33c and 33d travel to the wavelength separation filter 10 in parallel to each other. After that, the lights change the travelling directions inside the wavelength separation filter 10 so that the lights are sequentially on a single path.

The wavelength separation filter 10 that is used in the first embodiment described with reference to FIG. 1 is also used in the fifth embodiment. That is, the wavelength separation filter 10 is formed by bonding the surfaces of the prisms 1a, 1b, and 1c that make the apexes of 90 degrees so that the apexes of adjacent prisms are pointing opposite directions. The two surfaces that make the apex in each of the prisms 1a, 1b and 1c are half mirrors, each of which functions as a wave-length filter or a total reflection surface.

For example, the surface 5a of the prism 1a is the first wavelength filter that allows the optical signal having the wavelength λ₁ to pass through and reflects optical signals having wavelengths other than λ₁. The surface 5b where the prism 1a and the prism 1b are bonded is the second wavelength filter that reflects the optical signal having the wavelength λ₂ and allows optical signals having wavelengths other than λ₂ to pass through. The surface 5c where the prism 1b and the prism 1c are bonded is the third wavelength filter that reflects the optical signal having the wavelength λ₃ and allows the optical signal having the wavelength λ₄ to pass through. The surface 5d is formed, for example, as a total reflection surface that totally reflects incident light.

With this configuration, the light having the wavelength λ₄ that is emitted by the light-emitting element 33d (hereinafter, “light 43”) is reflected by the surface 5d and the reflected light 43 having the wavelength λ₄ passes through the surface 5c. The light having the wavelength λ₃ that is emitted by the light-emitting element 33c (hereinafter, “light 44”) is reflected by the surface 5c. The lights 43 and 44 are combined together, so that a combined light having the wavelengths λ₃ and λ₄ (hereinafter, “light 45”) is formed.

The light having the wavelength λ₂ that is emitted by the light-emitting element 33b (hereinafter, “light 46”) is reflected by the surface 5b. The reflected light 46 is combined with the light 45, so that a combined light 47 is formed. The light having the wavelength λ₁ that is emitted by the light-emitting element 33a (hereinafter, “light 48”) passes through the surface 5a. The light 48 is combined with the light 47, so that a combined light 49 is formed. The light 49 having the wavelengths λ₁, λ₂, λ₃ and λ₄ is output from the wavelength separation filter 10.

In the fifth embodiment, the wavelength separation filter 10 that has the same configuration as that used in the light-receiving device can be used, and accordingly, it is made possible to facilitate fabricating and packaging of the light-receiving device and the light-transmitting device.

As described heretofore, according to one aspect of the present invention, it is possible to maintain sensitivity of an optical module high enough for a long time and fabricate such an optical module in an easy manner by increasing a degree of tolerance.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An optical module comprising:
at least one wavelength separation unit that has side surfaces making an angle of 90 degrees, each of said side surfaces functioning as a wavelength filter that performs a wavelength selection on incident light; and
at least one light-receiving unit that receives the light from the wavelength separation unit, after the light enters and then exits the wavelength separation unit by way of the wavelength filter.

2. The optical module according to claim 1 including a plurality of wavelength separation units, wherein the wavelength separation units that are adjacent to each other are bonded so that the angles of 90 degrees of the adjacent wavelength separation units are pointing in opposite directions.

3. The optical module according to claim 2, further comprising a converting unit that converts light into collimated light, wherein
the light enters the wavelength separation unit after being collimated by the converting unit.

4. The optical module according to claim 3, including a plurality of wavelength separation units, wherein
the plurality of light receiving units are arranged so that each of the light receiving units is provided at a position suitable for receiving a corresponding wavelength of light that is separated from the incident light by the wavelength separation unit, and
the length of a path along which the light travels from an incident position on the wavelength separation unit to each of the light receiving units is substantially equal.

5. The optical module according to 2, wherein
the plurality of wavelength separation units are arranged in such a manner that each of the light that has entered a first wavelength separation unit is reflected by the side surfaces making an angle of 90 degrees and then exits the first wavelength separation unit from a base surface that is opposite to the angle of 90 degrees, and wherein
a surface that reflects the light reached to the last wavelength separation unit functions as a total reflection surface.

6. The optical module according to claim 1, wherein
the plurality of wavelength separation units include a first wavelength separation unit and a second wavelength separation unit attached to the first wavelength separation unit, wherein
the first wavelength separation unit has the side surfaces making an angle of 90 degrees and a base surface that is opposite to the angle of 90 degrees,
the light enters the first wavelength separation unit from the base surface and then exits from a corresponding side surface that is located at a position corresponding to a point on the base surface at which the light enters, and
the second wavelength separation unit is bonded to the corresponding side surface of the first wavelength separation unit so that a surface of the second wavelength separation unit is made parallel to the base surface of the first wavelength separation unit.

7. The optical module according to claim 1, wherein the light-receiving unit includes a telecentric optical system.

8. The optical module according to claim 1, comprising a light-emitting unit instead of the light-receiving unit.
